(19) United States
(12) Patent Application Publication
(10) Pub. No.: US 2006/0119242 A1
(43) Pub. Date: Jun. 8, 2006

(54) Plasma display device

(75) Inventors: Tae-Kyoung Kang, Suwon-si (KR); Ki-Jung Kim, Suwon-si (KR); Sok-San Kim, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG SDI CO., LTD.

(21) Appl. No.: 11/293,164

(22) Filed: Dec. 5, 2005

(30) Foreign Application Priority Data
Dec. 7, 2004 (KR) 10-2004-0102268

(51) Int. Cl. H01J 17/49

(52) U.S. Cl. 313/46; 313/582

(57) ABSTRACT

A plasma display device includes a plate member arranged at a distance from a circuit substrate to allow air to pass between the plate member and the circuit substrate. The plate member includes an extension arranged at an angle to the plate member to deflect heat generated by the driving circuits through a hole in the plasma display device cover.

### CROSS-REFERENCE TO RELATED APPLICATION

This application claims priority to and the benefit of Korean Patent Application No. 10-2004-0102268, filed on Dec. 7, 2004, which is hereby incorporated by reference for all purposes as if fully set forth herein.

### BACKGROUND OF THE INVENTION

1. Field of the Invention

The present invention relates to a plasma display device that may disperse and dissipate heat generated by a circuit substrate.

2. Discussion of the Background

A plasma display device displays images by applying a high voltage current to a discharge gas to generate ultraviolet rays, which in turn excite phosphor to emit visible light. A plasma display device may include a plasma display panel, a chassis base arranged on the plasma display panel, a circuit substrate arranged on the chassis base, various driving circuits arranged on the circuit substrate, and front and rear covers that enclose and protect the plasma display panel, chassis base, and circuit substrate.

A large amount of heat may be generated during the operation of the driving circuits. The generated heat may rise by convection and may cause thermal expansion of the upper elements of the plasma display device, which may damage the plasma display device and degrade the product quality.

### SUMMARY OF THE INVENTION

The present invention provides a plasma display device that includes an angled extension of a plate member that may disperse heat generated by a circuit substrate to prevent the plasma display device from being damaged by heat.

Additional features of the invention will be set forth in the description which follows, and in part will be apparent from the description, or may be learned by practice of the invention.

The present invention discloses a plasma display device that includes a plasma display panel, a chassis base attached to the plasma display panel, a circuit substrate attached to the chassis base, driving circuits arranged on the circuit substrate, a plate member arranged at a distance from the circuit substrate to allow air to pass between the plate member and the circuit substrate, and a cover with at least one vent hole, wherein the cover encloses the plasma display panel, the chassis base, the circuit substrate, the driving circuits, and the plate member, and wherein the plate member includes an extension arranged at an angle to the plate member to deflect heat generated by the driving circuits through the at least one vent hole in the cover.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view of a plasma display device according to an exemplary embodiment of the present invention

FIG. 2 is a partial enlarged perspective view of part of the plasma display device of FIG. 1.

FIG. 3 is a partial sectional side view of the assembled plasma display device of FIG. 1, cut in the vertical direction.

FIG. 4 is a sectional side view of part of a plasma display device according to an exemplary embodiment of the present invention.

FIG. 5 is a sectional side view of part of a plasma display device according to an exemplary embodiment of the present invention.

### DETAILED DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. The same reference numbers refer to the same elements. Repetitive explanations of the same reference numbers will be omitted.

It will be understood that when an element such as a layer, film, region or substrate is referred to as being “on” another element, it can be directly on the other element or intervening elements may also be present. In contrast, when an element is referred to as being “directly on” another element, there are no intervening elements present.

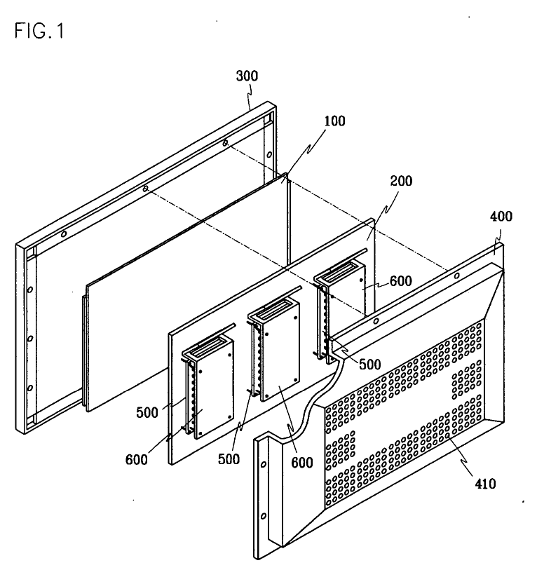

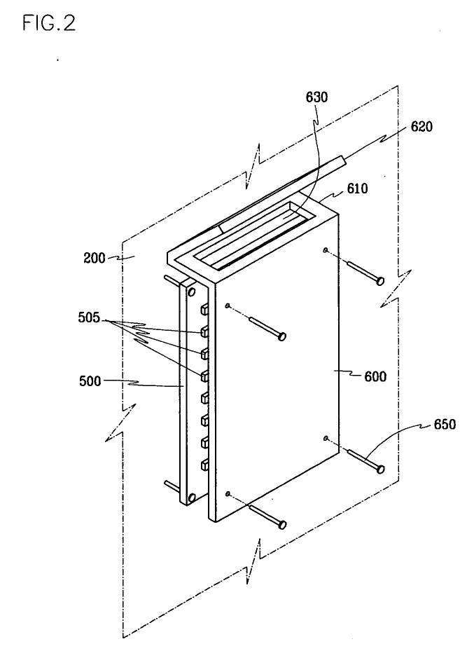

FIG. 1 is an exploded perspective view of a plasma display device according to an exemplary embodiment of the present invention. FIG. 2 is a partial enlarged perspective view of part of FIG. 1.

Referring to FIG. 1 and FIG. 2, a plasma display device may include a plasma display panel 100 (PDP), a chassis base 200 attached to a surface of the PDP 100, a circuit substrate 500 attached to the PDP 100, with circuit drivers 505 arranged on the circuit substrate 500, a front cover 300, and a rear cover 400. The circuit drivers 505 drive the PDP 100.

A plurality of vent holes 410 may be provided on the rear cover 400 so that air may pass through. The vent holes 410 are provided to dissipate heat generated by internal components, such as the circuit drivers 505, to the outside.

The circuit substrate 500 may be attached to the chassis base at a predetermined distance from the circuit substrate 500. The driving circuits may be installed on a surface of the circuit substrate 500 to drive the PDP 100.

A plate member 600 may be arranged on a surface of the circuit substrate 500 at a predetermined distance from the driving circuits 505. The plate member may be fixed by fastening members 650 such as screws. The plate member 600 is provided to shield noise generated by the driving circuits.

The plate member 600 may have a first extension 610 attached to the upper side of the plate member 600 and extending towards the chassis base, and a second extension 620 attached to the first extension 610 and extending towards the rear cover 400.

The first extension 610 includes a vent hole 630. The vent hole 630 may be large enough to allow air warmed by the heat generated by the driving circuits 505 to flow upward by convection and pass through without retention. In an exemplary embodiment of the present invention, only one vent hole 630 is shown. However, a plurality of vent holes 630 may be arranged on the first extension 610.

The second extension 620 may be angled towards the vent holes 410 in the rear cover 400. The second extension 620 may channel warm air rising vertically through the vent hole 630 in the first extension 610 towards the vent holes 410 in the rear cover 400 where the warm air will be discharged and dispersed.

The first extension 610 and the second extension 620 may be arranged in various configurations to channel heat generated by the driving circuits through the vent holes 410 in the rear cover 400. The size and shape of the first extension 610 and the second extension 620 may be varied. The angle of the first extension 610 and the second extension 620 with respect to the plate member 600 may be varied. The angle of the plate member 600 with respect to the circuit substrate 500 may be varied. The first extension 610 and the second extension 620 may be attached to each other and the plate member 600 at various locations.

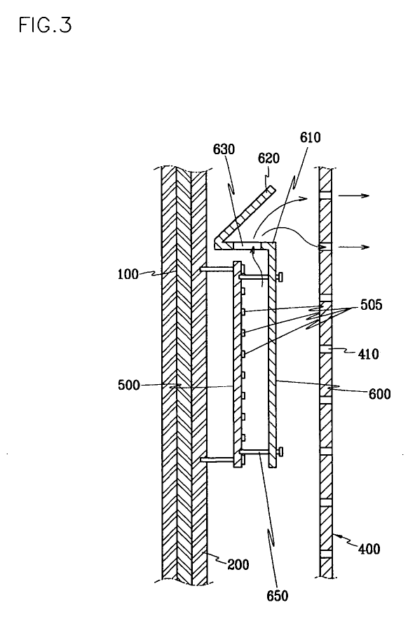

FIG. 3 is a partial sectional side view of an assembled plasma display device of FIG. 1, cut in the vertical direction.

Referring to FIG. 3, the PDP 100 displays an image by operating driving circuits 505 arranged on the circuit substrate 500. The driving circuits generate noise and heat. The plate member 600 attached to the circuit substrate 500 acts as a noise shield.

Air warmed by the driving circuits 505 flows upward by convection and passes through the vent hole 630 in the first extension 610. The warm air is then deflected by an inclined surface of the second extension 620 through the vent holes 410 in the rear cover 400, and is dissipated in the atmosphere.

The removal of heat from the plasma display device may eliminate or reduce damage caused by thermal expansion and may improve product quality.

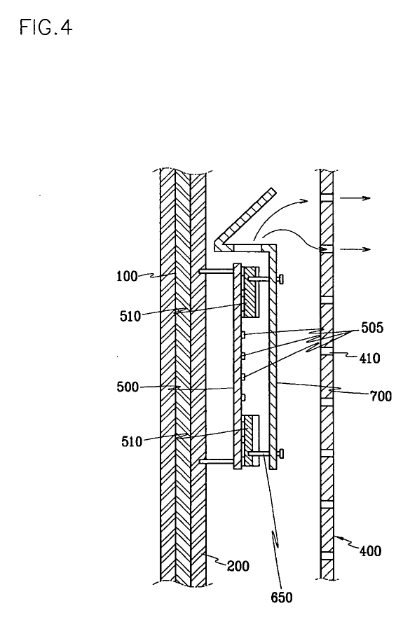

FIG. 4 is a sectional side view of part of a plasma display device according to an exemplary embodiment of the present invention.

Referring to FIG. 4, a plate member 700 is fixed to a heat sink 510 arranged on the circuit substrate 500.

The heat sink 510 is attached to heat-generating driving circuits 505 arranged on the circuit substrate 500 to improve cooling efficiency. At least one heat sink 510 may be installed to correspond to heat-generating devices arranged on the circuit substrate 500.

The plate member 700 may be fixed to the heat sink 510 by fastening members 650 such as screws at a predetermined distance to avoid interfering with the driving circuits arranged on the circuit substrate 500. Fixing the plate member 700 to the heat sink 510 instead of to the circuit substrate 500 may prevent damage to the circuit substrate 500 that might otherwise be incurred during the fastening process. Additionally, the plate member 700 may dissipate heat transferred from the heat sink 510 through the fastening members 650 to the plate member 700.

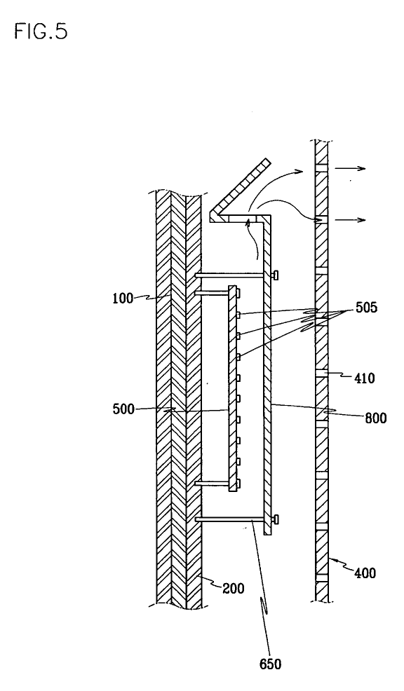

FIG. 5 is a sectional side view of part of a plasma display device according to an embodiment of the present invention.

Referring to FIG. 5, a plate member 800 is fixed to the chassis base 200. The plate member 800 may be arranged at a predetermined distance from the circuit substrate 500 to prevent interference with the driving circuits on the circuit substrate 500.

If the plate member 800 is fixed to the chassis base 200 by fastening members 650, such as screws, bosses (not shown) may be formed on the back side of the chassis base 200 to reinforce the strength of portions of the chassis base 200 attached to fastening members 650.

Fixing the plate member 800 to the chassis base 200 instead of to the circuit substrate 500 may prevent damage to the circuit substrate 500 that might otherwise be incurred during the fastening process, and may allow the plate member 800 to be fixed more securely.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display device, comprising:
a plasma display panel;
a chassis base attached to the plasma display panel;
a circuit substrate attached to the chassis base;
driving circuits arranged on the circuit substrate;
a plate member attached to the circuit substrate arranged at a distance from the circuit substrate to allow air to pass between the plate member and the circuit substrate; and
a cover with at least one vent hole,
wherein the cover encloses the plasma display panel, the chassis base, the circuit substrate, the driving circuits, and the plate member, and
wherein the plate member includes an extension arranged to deflect heat generated by the driving circuits through the at least one vent hole in the cover.

2. The plasma display device of claim 1, wherein the plate member is arranged at a predetermined distance from the circuit substrate.

3. The plasma display device of claim 2, wherein the extension comprises:
a first extension extending from the upper edge of the plate member towards the chassis base, the first extension including at least one vent hole; and
a second extension extending from the first extension towards a side of the cover that includes the at least one vent hole.

4. The plasma display device of claim 3,
wherein the plate member is arranged substantially parallel to the circuit substrate, and
wherein the first extension is arranged substantially perpendicular to the plate member.

5. The plasma display device of claim 4,
wherein the second extension is arranged at an angle of about 45 degrees or less to the first extension.

6. A plasma display device comprising:
a plasma display panel;
a chassis base attached to the plasma display panel;
a circuit substrate attached to the chassis base;
driving circuits arranged on the circuit substrate;
at least one heat sink attached to the circuit substrate;
a plate member attached to the heat sink; and
a cover with at least one vent hole;
wherein the cover encloses the plasma display panel, the chassis base, the circuit substrate, the driving circuits, and,
wherein the plate member includes an extension to deflect heat generated by the driving circuits through the at least one vent hole in the cover.

7. The plasma display device of claim 6, wherein the plate member is disposed maintaining a predetermined distance from the circuit substrate.

8. The plasma display device of claim 7, wherein the extension includes:
a first extension extending from the upper side of the plate member towards the chassis base, the first extension including at least one vent hole; and
a second extension extending from the first extension towards a side of the cover that includes the at least one vent hole.

9. The plasma display device of claim 8,
wherein the plate member is arranged substantially parallel to the circuit substrate, and
wherein the first extension is arranged substantially perpendicular to the plate member.

10. The plasma display device of claim 9,
wherein the second extension is arranged at an angle of about 45 degrees or less to the first extension.

11. A plasma display device comprising:
a plasma display panel;
a chassis base attached to the plasma display panel;
a circuit substrate attached to the chassis base;
driving circuits arranged on the circuit substrate;
a plate member attached to the chassis base; and
a cover with at least one vent hole;
wherein the cover encloses the plasma display panel, the chassis base, the circuit substrate, the driving circuits and the plate member, and,
wherein the plate member includes an extension arranged to deflect heat generated by the driving circuits through the at least one vent hole in the cover.

12. The plasma display device of claim 11, wherein the plate member is arranged at a predetermined distance from the circuit substrate.

13. The plasma display device of claim 12, wherein the extension includes:
a first extension extending from the upper edge of the plate member, bent towards the chassis base, and formed with a vent hole through which air may pass; and
a second extension extending from the first extension and bent with an inclination towards the vent holes in the cover.

14. The plasma display device of claim 13,
wherein the plate member is arranged substantially parallel to the circuit substrate, and
wherein the first extension is arranged substantially perpendicular to the plate member.

15. The plasma display device of claim 14,
wherein the second extension is arranged at an angle of about 45 degrees or less to the first extension.
